(19) United States
(12) Patent Application Publication
(10) Pub. No.: US 2025/0361180 A1
(43) Pub. Date: Nov. 27, 2025

(54) FACILITY AND METHOD FOR THE FORCED CARBONATION OF A FINE FRACTION OF A RECYCLED CONCRETE

(71) Applicant: FIVES FCB, VILLENEUVE-D'ASCQ (FR)

(72) Inventor: Alain CORDONNIER, VILLENEUVE D'ASCQ (FR)

(73) Assignee: FIVES FCB, VILLENEUVE-D'ASCQ (FR)

(21) Appl. No.: 18/867,892

(22) PCT Filed: Jun. 23, 2023
(86) PCT No.: PCT/FR2023/050957

§ 371 Date: Nov. 21, 2024

(30) Foreign Application Priority Data
Jun. 27, 2022 (FR) FR2206361

(51) Int. Cl. C04B 20/02; C04B 18/167; C04B 20/00

(52) U.S. Cl. CPC C04B 20/0232; C04B 18/167; C04B 20/0076

(57) ABSTRACT

A facility for the forced carbonation of a fine fraction of a recycled concrete, the facility including a carbonation reactor in which the fine fraction is able and intended to be brought into contact with a carbon dioxide-containing gas, a first water-spraying device able to increase the moisture content of the fine fraction, and a conditioning device able to manage the temperature and the relative humidity of the carbon dioxide-containing gas. The facility includes a computer control unit able to control the first spraying device and the device for conditioning the carbon dioxide-containing gas.

### TECHNICAL FIELD OF THE INVENTION

The invention relates to a facility and a method for the forced carbonation of a fine fraction originating from a prior process of dissociation from a recycled concrete. More specifically, the invention relates to a facility and a method consisting in trapping carbon dioxide in recycled concretes.

### TECHNICAL BACKGROUND

Carbon dioxide is a greenhouse gas. The amount of carbon dioxide gas in the terrestrial atmosphere has an impact on climate change.

There are several techniques for reducing carbon dioxide emissions. One of these techniques consists in trapping carbon dioxide in recycled concretes, in particular originating from the dismantling of old buildings or engineering works.

The recycled concretes comprise hydrated cement paste. The hydrated cement paste could be used, to some extent, as a carbon dioxide well. In other words, the hydrated cement paste could be used to capture carbon dioxide by bringing it into direct contact with the latter in order to reduce the amount of this greenhouse gas in the atmosphere.

In order to properly load these recycled concretes with carbon dioxide, these are exposed to carbon dioxide for several hours. This is incompatible with an industrial rate.

Aware of the problem, and to achieve industrial rates, attempts have consisted in reducing the time of exposure of the fine fraction to carbon dioxide to reach a few tens of minutes. Mixers intended to create stirring have been used, yet, the rate of capture of carbon dioxide in the recycled concretes has proved to be insufficient, reducing the efficiency of the process and therefore the interest of these operations.

Thus, current techniques are still to be improved. The aim is to be able to load the recycled concretes with carbon dioxide at an industrial rate, i.e. in a few tens of minutes at most. The objective is to unlock the technological limitation that hinders the use of recycled concretes by manufacturers as carbon dioxide wells.

### SUMMARY OF THE INVENTION

To this end, a facility is firstly provided for the forced carbonation of a fine fraction of a recycled concrete, the facility comprising:
a carbonation reactor in which the fine fraction is able and intended to be brought into contact with a carbon dioxide-containing gas,
a first water-spraying device able to increase the moisture content of the fine fraction, and
a conditioning device able to manage the temperature and the relative humidity of the carbon dioxide-containing gas,
   the facility comprising a computer control unit able to control the first spraying device and the device for conditioning the carbon dioxide-containing gas.

Various additional features can be provided alone or in combination:
the first spraying device is arranged upstream of the carbonation reactor according to the direction of movement of the fine fraction or inside said carbonation reactor in the vicinity of the inlet of the fine fraction;
the facility comprises a first device for measuring the moisture content in the fine fraction, said first measuring device being arranged upstream of the carbonation reactor, according to the direction of movement of the fine fraction;
the facility comprises a second device for measuring the relative humidity and/or the temperature of the gas in the carbonation reactor;
the facility comprises a circuit for injecting a carbon dioxide-containing gas in the carbonation reactor, said carbon dioxide-containing gas injection circuit being fluidly connected to a supply of fumes originating from a combustion;
the carbon dioxide-containing gas injection circuit comprises, arranged in the following order according to the direction of flow of the carbon dioxide-containing gas:
an outlet dryer intended to dry the carbonated fine fraction at the outlet of the carbonation reactor,
an aeraulic separation device able to separate the carbon dioxide-containing gas on the one hand from the carbonated and dried fine fraction on the other hand, said separation device comprising a first outlet through which the carbonated and dried fine fraction is intended to be discharged,
a volumetric distribution system able to manage the volume of carbon dioxide-containing gas sent towards the carbonation reactor,
a device for conditioning the carbon dioxide-containing gas able to modify the relative humidity and/or the temperature of the carbon dioxide-containing gas,
a device for injecting the carbon dioxide-containing gas into the carbonation reactor.

The invention secondly relates to a method for the forced carbonation of a fine fraction originating from a recycled concrete, this method could implement a facility as described before, the method comprising the following steps:
a step of conditioning the fine fraction so that said fine fraction has a predetermined moisture content substantially equal to a setpoint value, and
a step of conditioning the carbon dioxide-containing gas so that the relative humidity and/or the temperature of said gas are substantially equal to setpoint values,
a step of supplying the carbonation reactor with the fine fraction originating from a recycled concrete comprising hydrated cement paste, said fine fraction having a grain size smaller than or equal to 16 millimetres, said fine fraction having been conditioned beforehand during the step of conditioning the fine fraction,
a step of injecting the carbon dioxide-containing gas into the carbonation reactor, said gas having been conditioned beforehand during the gas conditioning step,
a step of carbonating the fine fraction in the carbonation reactor.

Various additional features can be provided alone or in combination:
the method comprising a step of measuring the moisture content in the fine fraction, the measurement being compared with a setpoint value, in which method the amount of water injected upstream of the carbonation reactor is adjusted so that the moisture content in the fine fraction is substantially equal to the setpoint value;
the method comprising a step of measuring the relative humidity and/or the temperature of the gas in the carbonation reactor, each of the measurement(s) being compared with a setpoint value, in which method the relative humidity and/or the temperature of the carbon dioxide-containing gas is or are modified during the step of conditioning the gas so that each of the relative humidity and/or the temperature in the carbonation reactor is or are substantially equal to the setpoint value;
the method comprising a step of drying the fine fraction by means of fumes originating from a combustion at the outlet of the carbonation reactor, the fine fraction being dried after having been carbonated;
the carbon dioxide injected into the carbonation reactor originates from fumes originating from a combustion;
the method comprises an aeraulic separation step carried out by means of the aeraulic separation device, during which step the dry and carbonated fine fraction is separated from the fumes;
the method comprises a step of volumetric distribution so as to send a predetermined amount of carbon dioxide towards the gas conditioning device;
the temperature in the carbonation reactor is comprised between 30° C. and 80° C., preferably 40° C.;
the relative humidity of the gases in the carbonation reactor is comprised between 40% and 100%;
the stay time of the fine fraction in the carbonation reactor is comprised between 20 minutes and 120 minutes;
the pressure inside the carbonation reactor is substantially equal to the atmospheric pressure;
the fine fraction has a grain size smaller than or equal to 6 millimetres.

### BRIEF DESCRIPTION OF THE FIGURES

Other features and advantages of the invention will appear upon reading the following detailed description for an understanding of which reference will be made to the appended drawing wherein:

FIG. 1 is a schematic representation of a facility according to the invention.

### DETAILED DESCRIPTION OF THE INVENTION

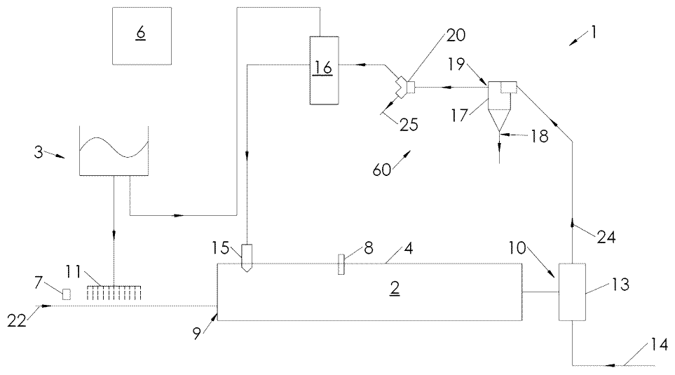

FIG. 1 shows a forced carbonation facility 1. The facility 1 comprises a carbonation reactor 2. The carbonation reactor 2 is intended to receive a fine fraction of a recycled concrete. The carbonation reactor 2 is able to bring the fine fraction into contact with carbon dioxide.

By “recycled concrete”, it should be understood concrete originating from the dismantling of buildings or engineering works, as well as, the wastes originating from concrete production units, for example and without limitation, the washing residues of vats, the remainings of spinning tops.

A fine fraction corresponds to the fraction of a recycled concrete having undergone an attrition or having been ground and whose grain size is smaller than or equal to 16 millimetres. Advantageously, the fine fraction has a grain size smaller than or equal to 6 millimetres.

The carbonation reactor 2 has an inlet 9 through which the fine fraction enters and an outlet 10 through which the fine fraction is evacuated.

The facility 1 comprises a first water-spraying device 11 able to spray water on the fine fraction. In FIG. 1, the first spraying device 11 is arranged upstream of the carbonation reactor 2 according to the direction of movement of the fine fraction.

According to a variant that is not shown, the first spraying device 11 is arranged inside the carbonation reactor 2, in the vicinity of the inlet 9.

The first spraying device 11 is fluidly connected to a water tank 3.

The first spraying device 11 allows spraying water directly on the fine fraction so as to increase its moisture content.

By acting on the moisture content of the fine fraction at the inlet 9 of the carbonation reactor 2, the fine fraction is set under the best conditions to be loaded with carbon dioxide during its stay in said carbonation reactor 2. By conditioning the fine fraction so as to obtain an optimum moisture content in the latter, the chemical reactivity of carbon dioxide with the fine fraction in the carbonation reactor 2 is improved. Thus, it becomes possible to obtain a carbonation of the fine fraction at an industrial rate.

Advantageously, the facility 1 comprises a first device 7 for measuring the moisture content of the fine fraction. The measuring device 7 is arranged upstream of the carbonation reactor 2. The measuring device 7 is arranged upstream of the spraying device 11 as shown in FIG. 1. In a variant that is not shown in FIG. 1, the measuring device 7 may be arranged downstream of the spraying device 11. This consists of a sensor able to communicate in real-time the obtained data to the unit 6.

The fine fraction initially has a moisture content lower than or equal to a determined setpoint value. By “initially”, it should be understood before the first spraying device 11 according to the direction of movement of the fine fraction.

The carbonation reactor 2 is in the form of a rotary drum 4. The rotary drum 4 is driven in rotation by means of at least one motor, not shown in the drawings.

Advantageously, the facility 1 comprises a computer control unit 6. The unit 6 allows controlling the facility 1.

Advantageously, the facility 1 comprises a second device 8 for measuring the relative humidity and the temperature of the gases in the carbonation reactor 2. This consists of a sensor measuring the relative humidity and the temperature of the gases in the carbonation reactor 2 and able to communicate in real-time the obtained data to the unit 6.

Advantageously, the facility 1 comprises an outlet dryer 13. The outlet dryer 13 is able to dry the carbonated fine fraction. Drying the carbonated fine fraction allows making it suited for transportation and storage.

The outlet dryer 13 is arranged at the outlet 10 of the carbonation reactor 2. The outlet dryer 13 thus arranged is able to dry the carbonated fine fraction as soon as it comes out of the carbonation reactor 2.

Advantageously, the outlet dryer 13 is fluidly connected to a supply 14 of fumes originating from a combustion. For example, this combustion is that one taking place in the burner of a cement kiln. Thus, the fumes originating from the kiln, loaded with carbon dioxide, are cooled down in the outlet dryer 13 and humidified at the same time. This has an advantage because these fumes contain carbon dioxide and will be brought into contact with the fine fraction in the carbonation reactor 2 as will be described later on. Indeed, the Applicant has determined after tests that the carbonation reaction is more effective when the carbon dioxide is at low temperature.

Advantageously, the facility 1 comprises a circuit 60 for injecting a carbon dioxide-containing gas. This circuit 60 includes, arranged in the following order according to the flow direction of the fumes:
an outlet dryer 13,
an aeraulic separation device 17,
a volumetric distribution system 20,
a device 16 for conditioning the carbon dioxide-containing gas,
a device 15 for injecting the carbon dioxide-containing gas.

The elements 13, 17, 20, 16, 15 are successively fluidly connected to one another.

The circuit 60 is fluidly connected to a fume supply 14. Thus, the fumes are conveyed towards the carbonation reactor 2 and injected into the latter.

Advantageously, the facility 1 comprises an aeraulic separation device 17 arranged downstream of the outlet dryer 13 for drying the fine fraction according to the flow direction of the fumes and of the fine fraction represented by the arrow 24.

From the outlet dryer 13, the fumes convey the fine fraction towards the aeraulic separation device 17. The aeraulic separation device 17 allows separating the fine fraction from the fumes. At a first outlet 18 of the aeraulic separation device 17, the carbonated fine fraction is evacuated while at a second outlet 19 of the aeraulic separation device 17, the fumes are sent in the direction of the conditioning device 16. Advantageously, the aeraulic separation device 17 is of the cyclone type and may further include a dynamic separator.

Advantageously, the facility 1 comprises a volumetric distribution system 20. The volumetric distribution system 20 is arranged between the aeraulic separation device 17 and the conditioning device 16. The volumetric distribution system 20 allows managing the volume of fumes sent towards the device 15 for injecting gases into the carbonation reactor 2 in order to send only the necessary amount of fume in said carbonation reactor 2. Thus, only the fumes that will be conveyed to the carbonation reactor 2 are conditioned. The rest of the fumes is evacuated towards an exhaust.

The conditioning device 16 allows regulating the moisture content and the temperature of the carbon dioxide-containing gas. Indeed, the relative humidity and the temperature being major factors in the carbonation reaction, the management of these is optimally performed using the conditioning device 16.

By optimising the temperature and the relative humidity of the gases in the chamber of the carbonation reactor 2, the carbonation reaction is accelerated, which allows reducing the stay time of the fine fraction in said carbonation reactor 2.

The increase in the relative humidity of the gas is carried out directly by adding water or water vapour. The reduction in the relative humidity of the gas is obtained by condensation of the water vapour. Thus, the packaging device 16 is fluidly connected to the water tank 3 in particular so that said device 16 draws water therein. Advantageously, the conditioning device 16 is able to cool down and heat the carbon dioxide-containing gas to obtain an optimum temperature. Thus, the conditioning device 16 is able to modify the temperature of the carbon dioxide-containing gas.

The conditioning device 16 is arranged between the volumetric distribution system 20 and the gas injection device 15. The conditioning device 16 thus arranged allows managing the relative humidity and the temperature of the carbon dioxide-containing gas before said gas is injected into the carbonation reactor 2.

In a preferred embodiment, the carbonation reactor 2 has a length substantially equal to 15 metres and a diameter of 1.6 metres. The carbonation reactor 2 is arranged so as to form an angle substantially equal to 2 degrees with the horizontal. The rotational speed is substantially equal to 1.5 revolutions per minute.

Next, a forced carbonation process implementing the facility will be described.

The fine fraction arrives at the facility 1 via an inlet 22.

The method comprises a step of conditioning the fine fraction. The fine fraction includes a grain size smaller than or equal to 16 millimetres. The fine fraction results from grinding or attrition of a recycled concrete. The fine fraction of a recycled concrete, i.e. that one whose grain size is smaller than 16 millimetres, is used for carbonation because its properties are conducive to a carbon dioxide loading. Advantageously, the grain size of the fine fraction is smaller than or equal to 6 millimetres, its properties then being optimum for carbon dioxide loading. The fine fraction comprises hydrated cement paste. This hydrated cement paste has carbon dioxide capture properties. This step of conditioning the fine fraction consists in managing the moisture content of the fine fraction upstream of the carbonation reactor 2. Management of the moisture content is carried out via an operation of water injection on the fine fraction. The operation of injecting water upstream of the carbonation reactor 2 is carried out by means of the first spraying device 11 which allows sprinkling the fine fraction with water. This conditioning of the fine fraction allows improving its carbon dioxide capture properties.

Advantageously, the method comprises a step of conditioning the carbon dioxide-containing gas. During this conditioning step, the carbon dioxide-containing gas is conditioned by regulating its temperature and its relative humidity in order to obtain optimum temperature and relative humidity in the carbonation reactor 2. This step is carried out by means of the conditioning device 16. The relative humidity corresponds to the ratio of the partial pressure of the steam and the saturation vapour pressure in the carbonation reactor 2. Hence, the aim is to maintain optimum temperature and relative humidity in the carbonation reactor 2 in order to increase the kinetics of capture of the carbon dioxide by the fine fraction.

The method comprises a step of supplying the carbonation reactor 2 with the fine fraction conditioned during the step of conditioning the fine fraction.

Advantageously, the method comprises a step of injecting the carbon dioxide-containing gas into the carbonation reactor 2. In the embodiment shown in the drawing, fumes originating from a combustion in a kiln and containing carbon dioxide are injected into the carbonation reactor 2.

Advantageously, the method comprises a step of carbonating the fine fraction in the carbonation reactor. This step is carried out by bringing the fine fraction into direct contact with the carbon dioxide-containing gas in the carbonation reactor 2.

Advantageously, the method comprises a step of measuring the moisture content in the fine fraction. This step is carried out by means of the first device 7 for measuring the moisture content in the fine fraction. The obtained measurements are sent towards the control unit 6. The control unit 6 compares the measurements with a predetermined setpoint value. Several scenarios could then appear:
the measured moisture content is lower than the setpoint value, the control unit 6 then controls the first spraying device 11 to spray water on the fine fraction;
the measured moisture content is equal to the setpoint value, the control unit 6 controls the first injection device not to spray water on the fine fraction.

Advantageously, the method comprises a step of measuring the relative humidity and the temperature in the carbonation reactor 2 by means of the second measuring device 8. The obtained measurements are sent towards the control unit 6. The control unit 6 compares the measurements with setpoint values. The control unit 6 then controls the conditioning device 16 to condition the carbon dioxide-containing gas so that its relative humidity and its temperature are substantially equal to said setpoint values.

Advantageously, the relative humidity in the carbonation reactor 2 is comprised between 40% and 100%. Thus, the setpoint value of the relative humidity is comprised in this interval. The Applicant has determined that a relative humidity comprised in this interval allows obtaining sufficiently rapid carbonation reaction kinetics to obtain industrial rates.

Advantageously, the temperature in the carbonation reactor 2 is comprised between 30 and 80° C. Thus, the setpoint value of the temperature is comprised in this interval. The Applicant has determined that a temperature comprised in this interval allows obtaining sufficiently rapid carbonation reaction kinetics to obtain industrial rates.

Once the fine fraction has completed its stay in the carbonation reactor 2 and it is consequently carbonated, it is dried by means of the outlet dryer 13. As mentioned before, the hot gas used in the outlet dryer 13 and which passes through the matter originates from a combustion, for example that of a cement kiln.

Referring to FIG. 1, the fumes coming out of the outlet dryer 13 convey the fine fraction up to the aeraulic separation device 17. The carbonated and dry fine fraction is evacuated through the first outlet 18. The fumes are evacuated through the second outlet 19.

The method comprises a step of volumetric distribution of the fumes. At the outlet of the aeraulic separation device 17, the fumes are sent towards the volumetric distribution system 20. During this step, the volumetric distribution device sends a given amount of fumes towards the conditioning device 16. The rest of the fumes is evacuated through an exhaust 25. Indeed, it is advantageous to condition only the necessary amount of fumes in order to maximise the overall efficiency of the facility.

At the outlet of the volumetric distribution system 20, the fumes are sent towards the conditioning device 16 in order to regulate their relative humidity and their temperature. Indeed, and to the extent that the fumes are used as a carbon dioxide-containing gas in the carbonation reactor 2, it is advantageous to condition them to obtain the favourable and optimum conditions of the carbonation reaction in the carbonation reactor 2.

The combustion fumes conditioned beforehand and then decarbonated, i.e. at least partially cleared of their carbon dioxide into the carbonation reactor 2, are evacuated afterwards through an exhaust outlet not shown in FIG. 1. In one variant, the decarbonated fumes may be sent towards another element of the facility.

Advantageously, the stay time of the fine fraction in the carbonation reactor 2 is comprised between 20 minutes and 120 minutes. This duration is acceptable in the context of production at an industrial rate and allows, in the context of the invention, a sufficient carbon dioxide loading level of the fraction in terms of amounts.

Advantageously, the pressure in the carbonation reactor 2 is substantially equal to the atmospheric pressure. Thus, the facility 1 is made less dangerous, less complex and less expensive, than a pressurised facility.

Advantageously, the fumes comprise at least 5% carbon dioxide by weight or by volume. Such fumes enable an effective carbon dioxide loading level in terms of amounts and speed.

1-18. (canceled)

19. A facility for the forced carbonation of a fine fraction of a recycled concrete, comprising:
a carbonation reactor in which the fine fraction is able and intended to be brought into contact with a carbon dioxide-containing gas,
a first water-spraying device able to increase the moisture content of the fine fraction, and
a conditioning device able to manage the temperature and the relative humidity of the carbon dioxide-containing gas,
the facility comprising a computer control unit able to control the first spraying device and the device for conditioning the carbon dioxide-containing gas.

20. The facility according to claim 19, wherein the first spraying device is arranged upstream of the carbonation reactor according to the direction of movement of the fine fraction or inside said carbonation reactor in the vicinity of the inlet of the fine fraction.

21. The facility according to claim 19, wherein the latter comprises a first device for measuring the moisture content in the fine fraction, said first measuring device being arranged upstream of the carbonation reactor, according to the direction of movement of the fine fraction.

22. The facility according to claim 19, wherein the latter comprises a second device for measuring the relative humidity and/or the temperature of the gas in the carbonation reactor.

23. The facility according to claim 22, wherein the latter comprises a circuit for injecting a carbon dioxide-containing gas in the carbonation reactor, said carbon dioxide-containing gas injection circuit being fluidly connected to a supply of fumes originating from a combustion.

24. The facility according to claim 23, wherein the carbon dioxide-containing gas injection circuit comprises, arranged in the following order according to the direction of flow of the carbon dioxide-containing gas:
an outlet dryer intended to dry the carbonated fine fraction at the outlet of the carbonation reactor,
an aeraulic separation device able to separate the carbon dioxide-containing gas on the one hand from the carbonated and dried fine fraction on the other hand, said separation device comprising a first outlet through which the carbonated and dried fine fraction is intended to be discharged,
a volumetric distribution system able to manage the volume of carbon dioxide-containing gas sent towards the carbonation reactor,
a device for conditioning the carbon dioxide-containing gas able to modify the relative humidity and/or the temperature of the carbon dioxide-containing gas,
a device for injecting the carbon dioxide-containing gas into the carbonation reactor.

25. A method for the forced carbonation of a fine fraction originating from a recycled concrete, this method could implement a facility according to claim 19, the method comprising the following steps:
a step of conditioning the fine fraction so that said fine fraction has a predetermined moisture content substantially equal to a setpoint value, and
a step of conditioning the carbon dioxide-containing gas so that the relative humidity and/or the temperature of said gas are substantially equal to setpoint values,
a step of supplying the carbonation reactor with the fine fraction originating from a recycled concrete comprising hydrated cement paste, said fine fraction having a grain size smaller than or equal to 16 millimetres, said fine fraction having been conditioned beforehand during the step of conditioning the fine fraction,
a step of injecting the carbon dioxide-containing gas into the carbonation reactor, said gas having been conditioned beforehand during the gas conditioning step,
a step of carbonating the fine fraction in the carbonation reactor.

26. The method according to claim 25, further comprising a step of measuring the moisture content in the fine fraction, the measurement being compared with a setpoint value, in which method the amount of water injected upstream of the carbonation reactor is adjusted so that the moisture content in the fine fraction is substantially equal to the setpoint value.

27. The method according to claims 25, further comprising a step of measuring the relative humidity and/or the temperature of the gas in the carbonation reactor, each of the measurement(s) being compared with a setpoint value, in which method the relative humidity and/or the temperature of the carbon dioxide-containing gas is or are modified during the step of conditioning the gas so that each of the relative humidity and/or the temperature in the carbonation reactor is or are substantially equal to the setpoint value.

28. The method according to claim 25, further comprising a step of drying the fine fraction by fumes originating from a combustion at the outlet of the carbonation reactor, the fine fraction being dried after having been carbonated.

29. The method according to claim 25, wherein the carbon dioxide injected into the carbonation reactor originates from fumes originating from a combustion.

30. The method according to claim 25, further comprising an aeraulic separation step carried out by the aeraulic separation device, during which step the dry and carbonated fine fraction is separated from the fumes.

31. The method according to claim 25, further comprising a step of volumetric distribution so as to send a predetermined amount of carbon dioxide towards the gas conditioning device.

32. The method according to claim 25, wherein the temperature in the carbonation reactor (2) is comprised between 30° C. and 80° C., preferably 40° C.

33. The method according to claim 25, wherein the relative humidity of the gases in the carbonation reactor is comprised between 40% and 100%.

34. The method according to claim 25, wherein the stay time of the fine fraction in the carbonation reactor is comprised between 20 minutes and 120 minutes.

35. The method according to claim 25, wherein the pressure inside the carbonation reactor is substantially equal to the atmospheric pressure.

36. The method according to claim 25, wherein the fine fraction has a grain size smaller than or equal to 6 millimetres.
